(19) United States
(12) Patent Application Publication
(10) Pub. No.: US 2022/0188730 A1
(43) Pub. Date: Jun. 16, 2022

(54) INFORMATION PROCESSING DEVICE, INFORMATION PROCESSING SYSTEM, AND PROGRAM

(71) Applicant: TOYOTA JIDOSHA KABUSHIKI KAISHA, Toyota-shi (JP)

(72) Inventors: Masato EHARA, Gotemba-shi (JP); Kazuhiro SHIMIZU, Sunto-gun (JP); Satoshi TANABE, Mishima-shi (JP); Nanae TAKADA, Susono-shi (JP); Naohiro SEO, Sunto-gun (JP)

(73) Assignee: TOYOTA JIDOSHA KABUSHIKI KAISHA, Toyota-shi (JP)

(21) Appl. No.: 17/473,125

(22) Filed: Sep. 13, 2021

(30) Foreign Application Priority Data
Dec. 15, 2020 (JP) 2020-207793

(51) Int. Cl. G06Q 10/06; G06Q 50/06; G06Q 10/08; G01W 1/10

(52) U.S. Cl. CPC G06Q 10/06315; G06Q 50/06; G01W 1/10; G06Q 10/06314; G06Q 10/0832; G06Q 10/063114

(57) ABSTRACT

An information processing device includes a processor including hardware. The processor: predicts a power generation amount of a next day and derive a predicted value of the power generation amount based on the weather information and the power generation information in the solar power generation facility; predicts a demand amount of electric power to be used in the predetermined area on the next day and derives a predicted value of the demand amount based on the weather information in the predetermined area; and outputs a request signal for requesting distribution of a distributed item from an outside of the predetermined area to the predetermined area based on the predicted value of the power generation amount and the predicted value of the demand amount.

### CROSS-REFERENCE TO RELATED APPLICATION

This application claims priority to Japanese Patent Application No. 2020-207793 filed on Dec. 15, 2020, incorporated herein by reference in its entirety.

### BACKGROUND

### 1. Technical Field

The present disclosure relates to an information processing device, an information processing system, and a program.

### 2. Description of Related Art

Japanese Unexamined Patent Application Publication No. 2017-191441 (JP 2017-191441 A) discloses a logistics business model of automatic logistics utilizing vehicles in which information communication is performed between a user, a business owner, a distribution operator, and a distribution driver working for the distribution operator so that the distribution driver working for the distribution operator performs distribution operation between the user and the business owner using vehicles.

### SUMMARY

However, there has been an issue on how to secure the power source of the moving body such as a vehicle, and the fuel cost cannot be stably secured at low cost. Thus, if the cost required for securing the power source is passed on to the user, the convenience of the moving body may be lowered. Therefore, there has been a demand for a technology that can effectively utilize surplus electric power in a logistics system.

The present disclosure has been made in view of the above, and an object thereof is to provide an information processing device, an information processing system, and a program capable of effectively utilizing surplus electric power in a logistics system within a predetermined area.

An information processing device according to the present disclosure is provided with a processor including hardware. The processor is configured to: acquire power generation information from a solar power generation server that outputs the power generation information related to power generation in a solar power generation facility, and store the power generation information in a storage unit; acquire weather information in a predetermined area and an area including the solar power generation facility from a weather information server that outputs the weather information related to weather, and store the weather information in the storage unit; predict a power generation amount of a next day and derive a predicted value of the power generation amount based on the weather information and the power generation information in the solar power generation facility; predict a demand amount of electric power to be used in the predetermined area on the next day and derive a predicted value of the demand amount based on the weather information in the predetermined area; and output a request signal for requesting distribution of a distributed item from an outside of the predetermined area to the predetermined area based on the predicted value of the power generation amount and the predicted value of the demand amount.

An information processing system according to the present disclosure includes: a first device including a first processor and configured to be able to deliver a distributed item to a predetermined facility, the first processor being configured to acquire delivery schedule information related to delivery of the distributed item and output an instruction signal for instructing autonomous movement based on the delivery schedule information; a second device including a solar panel that converts sunlight into electric power, a storage battery that stores the electric power generated by the solar panel, and a second processor configured to acquire and output power generation information related to power generation from at least one of the solar panel and the storage battery; a third device including a third processor configured to collect weather information; and a fourth device including a fourth processor configured to acquire the power generation information from the second device and store the power generation information in a storage unit, acquire the weather information in a predetermined area and an area including the second device from the third device and store the weather information in the storage unit, predict a power generation amount of a next day by the solar panel and derive a predicted value of the power generation amount based on the weather information and the power generation information in the second device, predict a demand amount of electric power to be used in the predetermined area on the next day and derive a predicted value of the demand amount based on the weather information in the predetermined area, and output a request signal for requesting distribution of a distributed item from an outside of the predetermined area to the predetermined area based on the predicted value of the power generation amount and the predicted value of the demand amount.

A program according to the present disclosure that causes a processor provided with hardware to: acquire power generation information from a solar power generation server that outputs the power generation information related to power generation in a solar power generation facility, and store the power generation information in a storage unit; acquire weather information in a predetermined area and an area including the solar power generation facility from a weather information server that outputs the weather information related to weather, and store the weather information in the storage unit; predict a power generation amount of a next day and derive a predicted value of the power generation amount based on the weather information and the power generation information in the solar power generation facility; predict a demand amount of electric power to be used in the predetermined area on the next day and derive a predicted value of the demand amount based on the weather information in the predetermined area; and output a request signal for requesting distribution of a distributed item from an outside of the predetermined area to the predetermined area based on the predicted value of the power generation amount and the predicted value of the demand amount.

According to the present disclosure, it is possible to effectively utilize surplus electric power in a logistics system within a predetermined area.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a distribution management system according to an embodiment;

FIG. 2 is a block diagram schematically showing a configuration of an area management server according to the embodiment;

FIG. 3 is a block diagram schematically showing a configuration of a work vehicle according to the embodiment;

FIG. 4 is a block diagram schematically showing a configuration of a distribution service provider server according to the embodiment;

FIG. 5 is a block diagram schematically showing a configuration of a solar power generation facility according to the embodiment;

FIG. 6 is a block diagram schematically showing a configuration of a weather information server according to the embodiment;

FIG. 7 is a schematic diagram showing a schematic configuration of a power generation facility and a charging facility according to the embodiment;

FIG. 8 is a flowchart illustrating a logistics management method according to the embodiment; and

FIG. 9 is a diagram illustrating an outline of distribution according to the embodiment.

### DETAILED DESCRIPTION OF EMBODIMENTS

Hereinafter, an embodiment of the present disclosure will be described below with reference to the drawings. In all the drawings of the following embodiments, the same or corresponding portions are designated by the same reference signs. Further, the present disclosure is not limited to the embodiment described below.

In recent years, studies have been made on an automatic logistics system using a solar power plant including a storage battery capable of supplying electric power to various facilities in a predetermined area called a smart city and using an electric moving body that moves with electric energy. The transported items are transported from outside the predetermined area to a distributed item handling office by an external distribution service provider. The distributed item handling office is a collection point in the predetermined area. From the distributed item handling office, the transported items are delivered to a delivery destination such as a residential facility in the predetermined area using an electric moving body for delivery. Thus, an automatic logistics system is realized within the predetermined area.

A large amount of electric power is generated in a solar power plant that supplies electric power to facilities in the predetermined area. In particular, due to solar power generation, surplus electric power may be generated on a sunny day, so effective utilization of the surplus electric power has been desired. In the automatic logistics system, the transportation and distribution of the distributed items are performed by the electric moving body. Thus, electric power is required to use the electric moving body. Therefore, the present disclosers devised a method to have a distribution service provider outside the predetermined area distribute the distributed items to the predetermined area when the next day is likely to be sunny, upon prediction of power generation amount using the sunshine hours at the solar power plant and prediction of the load, that is, the demand within the predetermined area. In this case, the electric power generated by the solar power generation can be used to perform distribution by the electric moving body on the day after the day when the external distribution service provider brings the distributed items to the collection point. In this way, the surplus electric power generated in the solar power plant can be effectively utilized, and the frequency and labor of distribution can be reduced for the distribution service provider. When conditions such as delivery date and time and express delivery are specified for the distributed item, the distributed item can be excluded from the above method. The embodiment described below is based on the above idea.

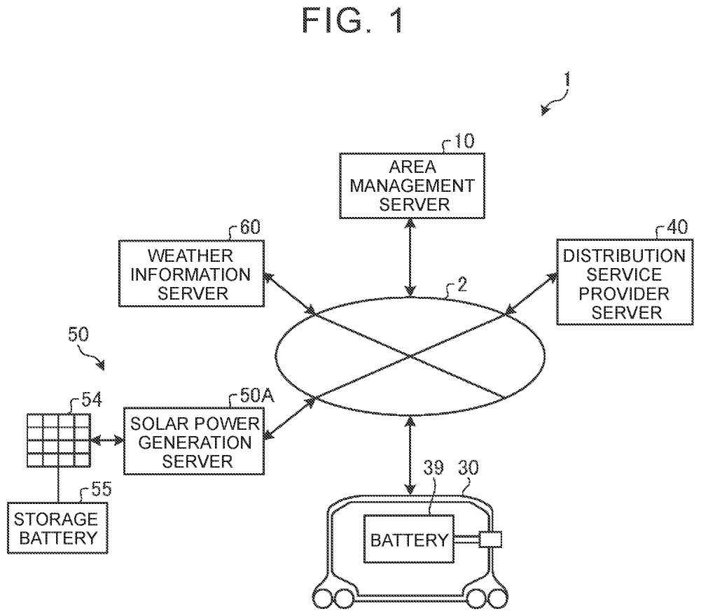

First, a distribution management system to which the information processing device according to the embodiment of the present disclosure can be applied will be described. FIG. 1 is a schematic view showing a distribution management system 1 according to the present embodiment. As shown in FIG. 1, the distribution management system 1 according to the present embodiment has an area management server 10, a work vehicle 30 equipped with a battery 39, a distribution service provider server 40, a solar power generation facility 50, and a weather information server 60 that can communicate with each other via a network 2. A plurality of work vehicles 30, distribution service provider servers 40, solar power generation facilities 50, and weather information servers 60 may be provided. In the following description, transmission/reception of information between the respective components is performed via a communication unit in each component and the network 2, but the description for each component will be omitted.

The network 2 is composed of, for example, the Internet network and a mobile phone network. The network 2 is, for example, a public communication network such as the Internet, and may include a telephone communication network such as a wide area network (WAN) and a mobile phone, and other communication networks such as a wireless communication network including WiFi (registered trademark).

Area Management Server

The area management server 10 serving as a movement management device for the work vehicle 30 can manage the movement of the work vehicle 30. The area management server 10 serving as an information processing device can manage distributed items within a predetermined area such as a smart city. In the present embodiment, various types of information such as vehicle information and movement information are supplied to the area management server 10 from each work vehicle 30 at a predetermined timing. The vehicle information includes, but is not necessarily limited to, vehicle identification information and sensor information. The sensor information includes, but is not necessarily limited to, energy remaining amount information related to the remaining energy amount such as the fuel remaining amount and the battery state of charge (SOC) of the work vehicle 30, and information related to traveling of the work vehicle 30 such as speed information and acceleration information. The movement information includes, but is not necessarily limited to, the position information and the traveling route information of the work vehicle 30. The area management server 10 can send and receive distribution information and schedule information as work information to and from the work vehicle 30.

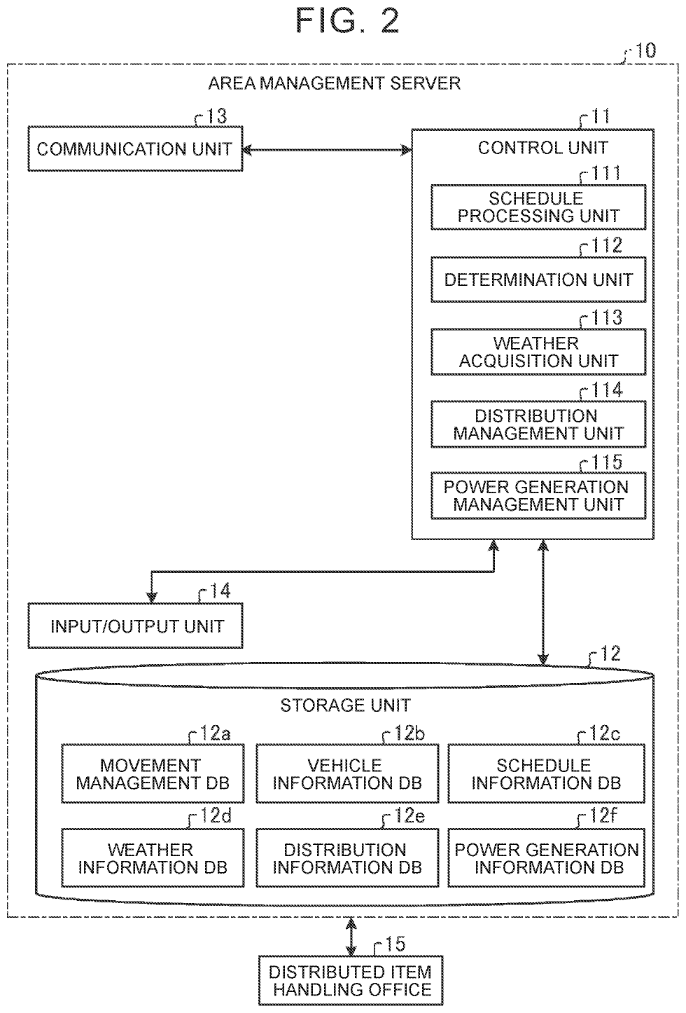

FIG. 2 is a block diagram schematically showing a configuration of the area management server 10. As shown in FIG. 2, the area management server 10 serving as a fourth device has a configuration of a general computer capable of communicating via the network 2. The area management server 10 includes a control unit 11, a storage unit 12, a communication unit 13, and an input/output unit 14.

The area management server 10 can manage the distributed item handling office 15. The distributed item handling office 15 is a facility that temporarily stores distributed items that are received within the predetermined area and distributed items brought in from outside the predetermined area so that the distributed items can be delivered to facilities and residential facilities within the predetermined area. The distributed item handling office 15 is provided, for example, at a position close to a charging facility 70 capable of charging the work vehicle 30. Here, the short distance refers to a distance within a range of several hundred meters to several kilometers. The charging facility 70 may be provided underground, and in this case, the distributed item handling office 15 can also be provided underground at a position close to the charging facility 70.

Specifically, the control unit 11 serving as a fourth processor provided with hardware is composed of a processor such as a central processing unit (CPU), a digital signal processor (DSP), and a field-programmable gate array (FPGA), and a main storage unit such as a random access memory (RAM) and a read-only memory (ROM).

The storage unit 12 includes, for example, a recording medium selected from an erasable programmable ROM (EPROM), a hard disk drive (HDD), and a removable medium, etc. Examples of the removable media include disc recording media such as a universal serial bus (USB) memory, a compact disc (CD), a digital versatile disc (DVD), and a Blu-ray (registered trademark) disc (BD). The storage unit 12 can store an operating system (OS), various programs, various tables, various databases, etc.

The control unit 11 loads the program stored in the storage unit 12 into the work area of the main storage unit and executes the program, and through the execution of the program, functions of a schedule processing unit 111, a determination unit 112, a weather acquisition unit 113, a distribution management unit 114, and a power generation management unit 115 can be realized. When a learning model serving as a program is used in the schedule processing unit 111, the learning model uses an input/output data set composed of a predetermined input parameter and an output parameter as teacher data. The learning model can be generated by machine learning such as deep learning using a neural network. The same applies to the determination unit 112, the weather acquisition unit 113, the distribution management unit 114, and the power generation management unit 115. Thus, the control unit 11 can realize the functions of the schedule processing unit 111, the determination unit 112, the weather acquisition unit 113, the distribution management unit 114, and the power generation management unit 115 by the learning model.

For example, the power generation management unit 115 can derive a predicted value of a power generation amount in the solar power generation facility 50. Specifically, for example, the power generation management unit 115 can derive the predicted value of the power generation amount of solar power generation at predetermined time intervals by using the predicted values of the solar radiation amount, the temperature, and the humidity. Further, the power generation management unit 115 uses an input/output data set in which the derived predicted value is used as a learning input parameter and the measured value of the power generation amount is used as a learning output parameter, for example, to perform deep learning. Thus, a predictive learning model for the power generation amount can be generated. As a result, the power generation management unit 115 can acquire the predicted values of the solar radiation amount, the temperature, and the humidity of the next day, derive the predicted value of the power generation amount, and input the derived predicted value as an input parameter to the predictive learning model. The predictive learning model can output the power generation amount by solar power generation as an output parameter, and thus can predict the power generation amount more accurately. A predictive learning model for the power generation amount may be generated by using the predicted values of the solar radiation amount, the temperature, and the humidity as learning input parameters and the measured value of the power generation amount as a learning output parameter.

Similarly to deriving the predicted value of the power generation amount, the power generation management unit 115 can generate a predictive learning model for predicting the demand amount, which can derive the predicted value of the demand amount in the predetermined area. Specifically, for example, the power generation management unit 115 can derive the predicted value of the demand amount for electric power in the predetermined area by using the power generation information, the weather forecast, and the predicted values of the solar radiation amount, the temperature, and the humidity. Further, the power generation management unit 115 uses an input/output data set in which the derived predicted value is used as a learning input parameter and the measured value of the demand amount is used as a learning output parameter, for example, to perform deep learning. Thus, a predictive learning model for the demand amount can be generated. Thus, the power generation management unit 115 acquires the weather forecast and the predicted values of the solar radiation amount, the temperature, and the humidity of the next day, and derives the predicted value of the demand amount. The power generation management unit 115 can input the derived predicted value to the predictive learning model as an input parameter. The predictive learning model can output the demand amount in the predetermined area as an output parameter, and can predict the demand amount more accurately. A predictive learning model for the demand amount may be generated by using the weather forecast and the predicted values of the solar radiation amount, the temperature, and the humidity as learning input parameters and the measured value of the demand amount as a learning output parameter.

A plurality of databases in which various types of data are stored in a searchable manner are stored in the storage unit 12. The storage unit 12 stores a movement management database 12a, a vehicle information database 12b, a schedule information database 12c, a weather information database 12d, a distribution information database 12e, and a power generation information database 12f For these databases 12a to 12f, for example, a relational database (RDB) can be adopted. In the present embodiment, the database (DB) can be established when the program of the database management system (DBMS) executed by the processor manages the data stored in the storage unit 12.

In the movement management database 12a, the vehicle identification information of the vehicle information is associated with other information such as the movement information, and is stored in an updateable, deletable, and searchable manner. The vehicle information database 12b stores sensor information and the like in the work vehicle 30, which is associated with the vehicle identification information in an updateable, deletable, and searchable manner.

The schedule information database 12c stores information related to the movement schedule of the work vehicle 30 and the distribution vehicle 45 owned by the distribution service provider (hereinafter, schedule information) in an updateable, deletable, and searchable manner. The schedule information is stored in the schedule information database 12c in association with the vehicle identification information of the work vehicle 30 and the distribution vehicle 45.

The weather information database 12d stores the weather information acquired from the weather information server 60 in an updateable, deletable, and searchable manner. The weather information is various types of information related to the weather collected by the weather information server 60, and includes information associated with the map, such as the average amount of solar radiation, the time of solar radiation, changes in the weather such as rain and cloudy weather, the weather forecast, and the outside temperature. The weather information includes the weather information in the solar power generation facility 50 and the weather information in the predetermined area to which the electric power generated in the solar power generation facility 50 is supplied.

The distribution information database 12e stores the distribution information acquired from the distribution service provider server 40 in an updateable, deletable, and searchable manner. The distribution information includes various types of information related to the distributed item to be distributed by the distribution vehicle 45 and the distributed item to be delivered by the work vehicle 30, such as information on the delivery destination of the distributed item and information on the delivery date and time. The distribution information can also be included in the schedule information.

The vehicle identification information assigned to each work vehicle 30 is stored in the movement management database 12a in a searchable manner. The vehicle identification information includes various types of information for identifying the individual work vehicles 30 from each other, and includes information necessary for accessing the area management server 10 when transmitting information related to the work vehicle 30. The vehicle identification information is also transmitted when the work vehicle 30 transmits various types of information. When the work vehicle 30 transmits predetermined information such as the movement information together with the vehicle identification information to the area management server 10, the control unit 11 of the area management server 10 stores the predetermined information in the movement management database 12a in a searchable manner and in association with the vehicle identification information.

The communication unit 13 is, for example, a local area network (LAN) interface board or a wireless communication circuit for wireless communication. The LAN interface board and the wireless communication circuit are connected to the network 2 such as the Internet, which is a public communication network. The communication unit 13 is connected to the network 2 and can communicate with the work vehicle 30, the distribution service provider server 40, the solar power generation facility 50, and the weather information server 60. The communication unit 13 receives the vehicle identification information, the vehicle information, and the movement information unique to the work vehicle 30 from each work vehicle 30, and transmits various instruction signals and confirmation signals to each work vehicle 30. The communication unit 13 can transmit and receive distribution information to and from the distribution service provider server 40. The communication unit 13 can transmit and receive power generation information to and from the solar power generation facility 50. The communication unit 13 can transmit and receive weather information to and from the weather information server 60.

The input/output unit 14 may be composed of, for example, a touch panel display, a speaker microphone, or the like. The input/output unit 14 serving as an output unit is configured to notify predetermined information to the outside according to the control by the control unit 11. The input/output unit 14 can display characters, figures, and the like on the screen of a display such as a liquid crystal display, an organic electroluminescent (EL) display, or a plasma display, and can output sound from a speaker. The input/output unit 14 includes a printer that outputs predetermined information by printing the information on printing paper or the like. Various types of information stored in the storage unit 12 can be confirmed, for example, on the display of the input/output unit 14 installed in a predetermined office or the like. The input/output unit 14 serving as an input unit is composed of, for example, a keyboard or a touch panel keyboard incorporated in the input/output unit 14 to detect a touch operation on the display panel, or a voice input device capable of making a call to the outside. By inputting predetermined information from the input/output unit 14 of the area management server 10, it is possible to remotely manage the movement of the work vehicle 30, so that the movement of the work vehicle 30 that is an autonomous driving vehicle capable of autonomous driving can be easily managed.

Delivery Vehicle

The work vehicle 30 that is a delivery vehicle serving as a moving body as the first device is a moving body capable of performing a plurality of types of predetermined tasks such as collection, transportation, and delivery of mail and distributed items. An autonomous driving vehicle configured to be capable of autonomously traveling according to a movement command given by the area management server 10, a predetermined program, or the like can be adopted as the moving body.

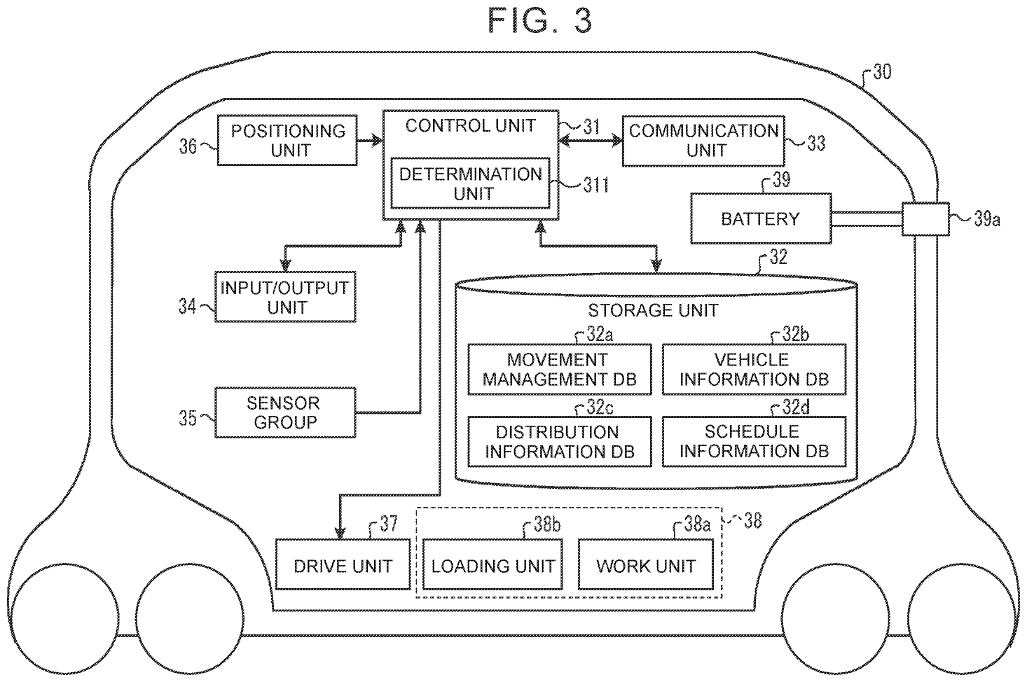

FIG. 3 is a block diagram schematically showing a configuration of the work vehicle 30. As shown in FIG. 3, the work vehicle 30 includes a control unit 31, a storage unit 32, a communication unit 33, an input/output unit 34, a sensor group 35, a positioning unit 36, a drive unit 37, a functional unit 38 including a work unit 38a and a loading unit 38b, and a battery 39 connected to the connector 39a. For example, a moving body equipped with an automatic collection/delivery robot or the like can be adopted as the work vehicle 30. The control unit 31, the storage unit 32, the communication unit 33, and the input/output unit 34 have the same physical and functional configurations as the control unit 11, the storage unit 12, the communication unit 13, and the input/output unit 14, respectively.

The control unit 31 serving as the first processor including hardware comprehensively controls the operation of various components mounted on the work vehicle 30. The control unit 31 can realize the function of the determination unit 311 by reading the program stored in the storage unit 32.

The storage unit 32 can store a movement information database 32a, a vehicle information database 32b, a distribution information database 32c, and a schedule information database 32d. The movement information database 32a stores various types of data including the movement information provided by the area management server 10 in an addable and updateable manner. The vehicle information database 32b stores various types of information including the battery SOC, the remaining fuel amount, the current position, and the like in an addable and updateable manner. The distribution information database 32c stores various types of information related to the distributed items collected and delivered by the functional unit 38 of the work vehicle 30 in an updateable, deletable, and searchable manner. The schedule information database 32d stores the schedule information of the movement of the corresponding work vehicle 30 in an updateable, deletable, and searchable manner.

The communication unit 33 communicates with the area management server 10 by wireless communication via the network 2. The input/output unit 34 serving as an output unit is configured so that predetermined information can be notified to the outside. The input/output unit 34 serving as an input unit is configured so that a user or the like can input predetermined information to the control unit 31.

The sensor group 35 includes sensors related to the traveling of the work vehicle 30, such as a vehicle speed sensor, an acceleration sensor, and a fuel sensor. The sensor group 35 may include, for example, a vehicle cabin sensor capable of detecting various situations in the vehicle cabin, an image sensor such as a complementary metal oxide semiconductor (CMOS) camera or a charge coupled device (CCD) camera capable of imaging the inside of the work vehicle 30, and an image capturing unit composed of an imaging element. The sensor information including the image information detected by the various sensors constituting the sensor group 35 is output to the control unit 31 via the vehicle information network (control area network (CAN)) composed of the transmission lines connected to the various sensors. In the present embodiment, the sensor information collected by the sensor group 35 constitutes a part of the vehicle information.

The positioning unit 36 serving as a position information acquisition unit receives radio waves from a global positioning system (GPS) satellite and detects the position of the work vehicle 30. The detected position is stored in a searchable manner in the vehicle information database 32b as the position information in the vehicle information. As a method for detecting the position of the work vehicle 30, a method combining light detection and ranging or laser imaging detection and ranging (LiDAR) system and a three-dimensional digital map may be adopted. Further, the position information may be included in the movement information, and the position information of the work vehicle 30 detected by the positioning unit 36 may be stored in the movement information database 32a.

The drive unit 37 is a drive unit for causing the work vehicle 30 to travel. Specifically, the work vehicle 30 includes a motor as a drive source. The motor is driven by electric energy from the battery 39. The work vehicle 30 includes a drive transmission mechanism for transmitting a driving force of the motor, drive wheels for traveling, and the like.

The functional unit 38 has the work unit 38a and the loading unit 38b. The work unit 38a of the functional unit 38 can perform a storage operation of acquiring a distributed item or a mail item (hereinafter collectively referred to as a distributed item) from the distributed item handling office 15 serving as a collection/delivery facility and storing the distributed item in the loading unit 38b. The loading unit 38b of the functional unit 38 is a storage area for storing the distributed item collected by the work unit 38a. Further, the work unit 38a can perform delivery work serving as a second work of receiving the distributed item from the distributed item handling office 15, loading the distributed item on the loading unit 38b, and delivering the distributed item after moving to a delivery destination facility, a residential facility, or the like within the predetermined area.

Distribution Service Provider Server

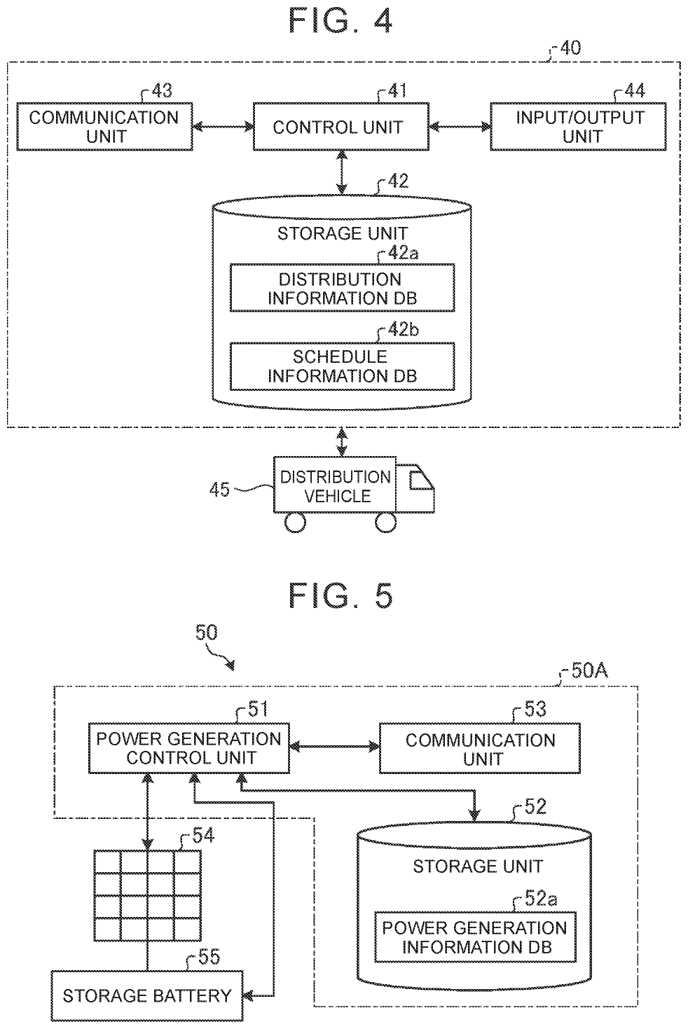

The distribution service provider server 40 serving as a fifth device is a server managed by a service provider that carries the distributed item from the outside to the distributed item handling office 15 in the predetermined area such as a smart city, or that carries out the distributed item from the distributed item handling office 15, which is to be delivered from the predetermined area to the outside. FIG. 4 is a block diagram schematically showing a configuration of the distribution service provider server 40. As shown in FIG. 4, the distribution service provider server 40 has a configuration of a general computer capable of communicating via the network 2, and includes a control unit 41, a storage unit 42, a communication unit 43, and an input/output unit 44. The distribution service provider server 40 can transmit and receive the distribution information to and from the area management server 10 via the communication unit 43 and the network 2.

The control unit 41 serving as a fifth processor including hardware, the storage unit 42, the communication unit 43, and the input/output unit 44 have the same physical and functional configurations as the control unit 11, the storage unit 12, the communication unit 13, and the input/output unit 14, respectively. The storage unit 42 can store the OS, various programs, various tables, and various databases, such as the distribution information database 72a and the schedule information database 42b. The distribution service provider server 40 can manage the distribution vehicle 45. The distribution vehicle 45 is a moving body managed by a service provider and capable of going back and forth between a distributed item handling office 15 and a collection/delivery facility such as a collection/delivery center, a logistics center, and a post office.

Solar Power Generation Facility

The solar power generation facility 50 is a facility capable of generating electric power to be supplied to each facility in a predetermined area such as a smart city by solar power. FIG. 5 is a block diagram schematically showing a configuration of the solar power generation facility 50. As shown in FIG. 5, the solar power generation facility 50 includes a solar power generation server 50A serving as a second device. The solar power generation server 50A has a configuration of a general computer capable of communicating via the network 2, and includes a power generation control unit 51, a storage unit 52, and a communication unit 53. The power generation control unit 51 serving as a second processor including hardware, the storage unit 52, and the communication unit 53 have the same physical and functional configurations as the control unit 11, the storage unit 12, and the communication unit 13, respectively. The power generation information database 52a is stored in the storage unit 52.

The solar power generation facility 50 includes a solar panel 54 and a storage battery 55 controlled by the solar power generation server 50A. The solar panel 54 is configured to include a plurality of solar cells that convert sunlight into electricity. The storage battery 55 is configured to be capable of storing the electric power generated by the solar panel 54. The solar panel 54 and the storage battery 55 are controlled by the power generation control unit 51 of the solar power generation server 50A. Various types of information related to solar power generation such as the power generation amount, power generation efficiency, operating rate, and charge amount acquired by the power generation control unit 51 from the solar panel 54 and the storage battery 55 are stored in the power generation information database 52a as power generation information.

Weather Information Server

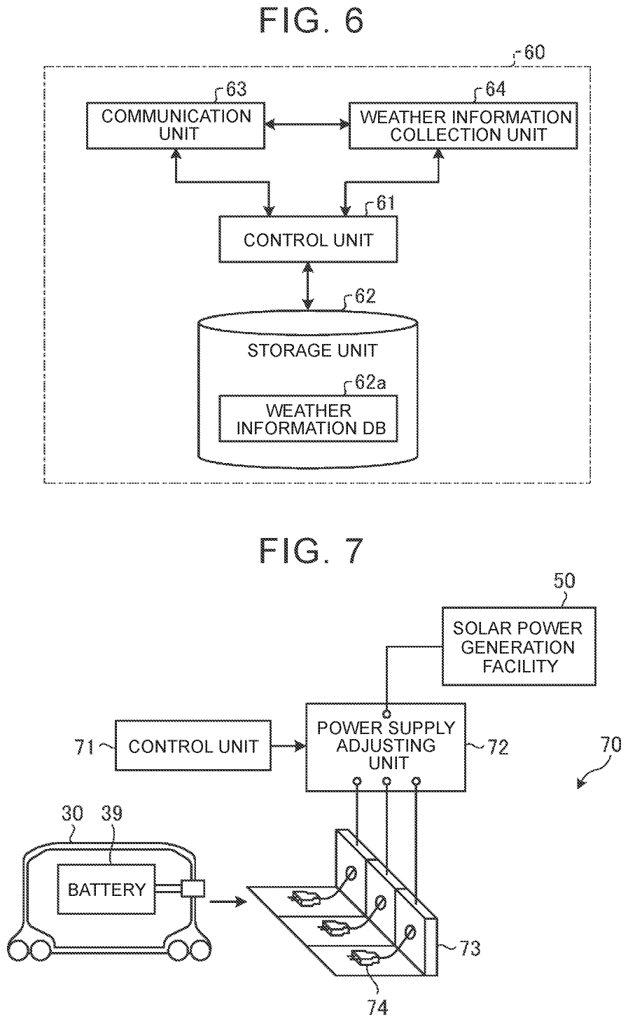

The weather information server 60 serving as a third device can collect the weather information of the area including the solar panel 54 in the solar power generation facility 50. FIG. 6 is a block diagram schematically showing a configuration of the weather information server 60. As shown in FIG. 6, the weather information server 60 includes a control unit 61, a storage unit 62, a communication unit 63, and a weather information collection unit 64. The control unit 61 serving as a third processor including hardware, the storage unit 62, and the communication unit 63 are functionally the same as the control unit 11, the storage unit 12, and the communication unit 13, respectively. The storage unit 62 can store various programs, various tables, various databases, and the like, such as the OS and the weather information database 62a. The weather information database 62a is composed of information related to the weather such as the solar radiation amount, sunshine duration, and weather and temperature acquired from a meteorological satellite or another weather information server.

The weather information collection unit 64 collects weather information from, for example, weather observation instruments installed in various places via the communication unit 63. The weather information collected by the weather information collection unit 64 is stored in a searchable manner in the weather information database 62a of the storage unit 62. Note that the weather information collection unit 64 may further include a storage unit. Further, the weather information collection unit 64 may be configured separately from the control unit 61, the storage unit 62, and the communication unit 63.

Charging Facility

Next, the charging facility 70 controlled by the area management server 10 will be described. FIG. 7 is a schematic diagram showing a schematic configuration of the charging facility according to the present embodiment.

As shown in FIG. 7, the charging facility 70 includes a control unit 71, a power supply adjusting unit 72, and a charging equipment 73 including plugs 74. Electric power is supplied to the power supply adjusting unit 72 of the charging facility 70 by a supply electric wire from the solar power generation facility 50 that generates electricity. Electric power may be supplied to the power supply adjusting unit 72 of the charging facility 70 from a thermal power generation facility, a nuclear power generation facility, or other renewable energy power generation facilities. The plugs 74 provided in the charging equipment 73 are electrically connected to the power supply adjusting unit 72 so as to be connectable to the connector 39a of the work vehicle 30. Thus, the charging facility 70 is configured to be able to supply electric power to the work vehicle 30. The charging facility 70 may be provided at a short distance from the distributed item handling office 15. Here, the short distance refers to a distance within a range of several hundred meters to several kilometers. Further, the charging facility 70 may be provided underground.

The control unit 71 may employ the control unit 11 of the area management server 10 or an independent control unit. The control unit 71 is configured to be able to input SOC information from each work vehicle 30. When the power supply adjusting unit 72 controlled by the control unit 71 supplies electric power to a plurality of work vehicles 30, for example, the power supply adjusting unit 72 can supply electric power by the electric power amount corresponding to the SOC of each work vehicle 30, for example, the electric power amount proportional to the reciprocal of the SOC.

Logistics Management Method

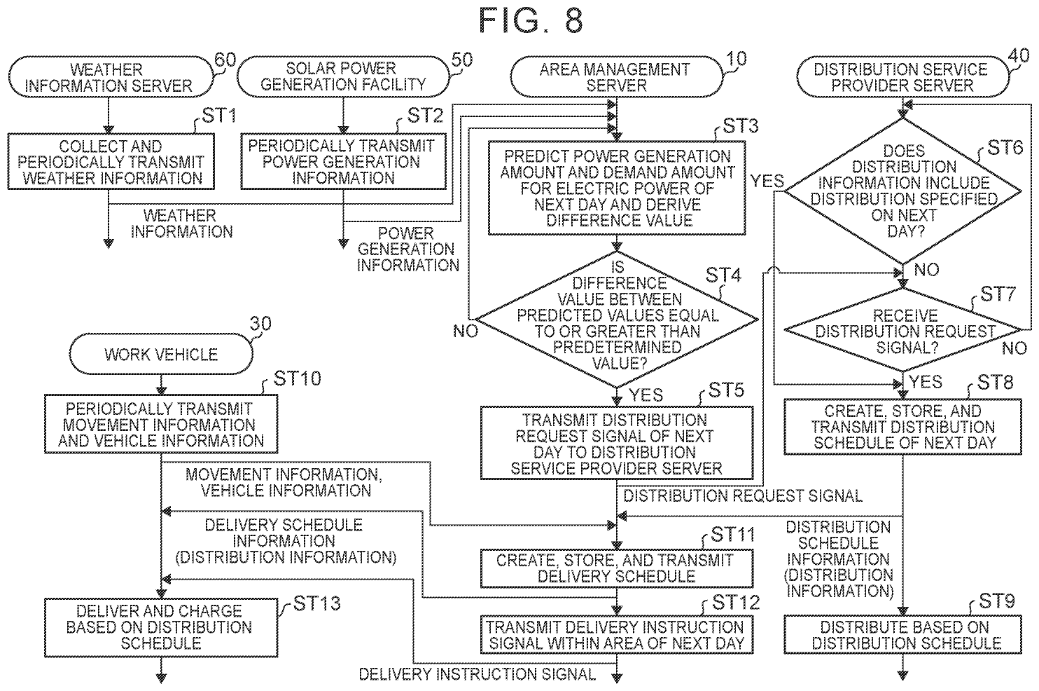

Next, a logistics management method according to the present embodiment will be described. FIG. 8 is a flowchart illustrating a logistics management method according to the present embodiment. In the following description, information is transmitted and received via the network 2. However, the description of transmission and reception via the network 2 will be omitted. Further, when information is transmitted and received between the area management server 10 and the work vehicle 30, the distribution service provider server 40, the solar power generation facility 50, and the weather information server 60, identification information that identifies each individual is also included in the transmitted/received information. However, the description of transmission and reception of the identification information will be omitted. Further, the flowchart shown in FIG. 8 shows the processing executed by the area management server 10 in the predetermined area in one day, and the flow shown in FIG. 8 can be executed once or a plurality of times in one day.

As shown in FIG. 8, first, in step ST1, the weather information collection unit 64 of the weather information server 60 collects the weather information periodically or as necessary and stores the weather information in the weather information database 62a of the storage unit 62. Further, the control unit 61 of the weather information server 60 reads the weather information periodically or as necessary from the weather information database 62a of the storage unit 62 and transmits the weather information to the area management server 10. The weather acquisition unit 113 of the area management server 10 that has received the weather information stores the received weather information in the weather information database 12d of the storage unit 12. The weather acquisition unit 113 may transmit an acquisition signal to the weather information server 60 via the communication unit 13, and the weather information server 60 may transmit the weather information to the area management server 10 in response to the reception of the acquisition signal.

In step ST2, the power generation control unit 51 of the solar power generation facility 50 collects periodically or as necessary the power generation information from the solar panel 54 and the storage battery 55, and stores the power generation information in the power generation information database 52a of the storage unit 52. Further, the power generation control unit 51 of the solar power generation facility 50 reads periodically or as necessary the power generation information from the power generation information database 52a of the storage unit 52, and transmits the power generation information to the area management server 10. The power generation management unit 115 of the area management server 10 that has received the power generation information stores the received power generation information in the power generation information database 12f of the storage unit 12. The power generation management unit 115 may transmit an acquisition signal to the solar power generation facility 50 via the communication unit 13, and the solar power generation facility 50 may transmit the power generation information to the area management server 10 in response to the reception of the acquisition signal.

In step ST3, the power generation management unit 115 of the control unit 11 of the area management server 10 derives the fluctuation of the solar radiation amount of the next day based on the acquired power generation information and the weather information, and derives the predicted value of the power generation amount generated by the solar panel 54. Further, the power generation management unit 115 derives a predicted value of the demand amount of electric power to be used on the next day in the predetermined area based on the acquired power generation information and weather information. The predicted value can be derived by the following formula, for example.

Predicted value of power generation amount (kWh)=Predicted value of solar radiation amount (kWh/m²)×Solar panel capacity (kW)×(1−predicted value of loss) (Note that the predicted value of loss is greater than zero and less than one)

Next, the power generation management unit 115 derives the difference value between the predicted value of the power generation amount and the predicted value of the demand amount of the next day (the predicted value of the power generation amount of the next day−the predicted value of the demand amount of the next day), and outputs the derived difference value of the next day to the determination unit 112.

Next, in step ST4, the determination unit 112 determines whether the acquired difference value of the next day is equal to or greater than a predetermined value. Here, the predetermined value can be set to various values, such as 10% or more with respect to the average value of the demand amount of the electric power in facilities existing in the predetermined area, 30% or more with respect to the average value of the power generation amount in the solar power generation facility 50, and the like. That is, in the present embodiment, the predetermined value can be set to a value at which it can be determined that the power generation amount in the solar power generation facility 50 is surplus with respect to the demand amount. When the determination unit 112 determines that the difference value of the next day is less than a predetermined value (step ST4: No), the process returns to step ST3. Step ST3 can be performed at least once a day. When the determination unit 112 determines that the difference value of the power generation amount of the next day is equal to or greater than the predetermined value (step ST4: Yes), the process proceeds to step ST5. In step ST5, the determination unit 112 of the control unit 11 transmits a distribution request signal to the distribution service provider server 40.

In the distribution service provider server 40 in step ST6, the control unit 41 reads the distribution information from the distribution information database 42a, and based on the read distribution information, determines whether the distribution information includes an instruction indicating that the delivery within the predetermined area is specified on the next day. When the control unit 41 determines that the distribution information does not include the instruction indicating that the delivery within the predetermined area is specified on the next day (step ST6: No), the process proceeds to step ST7. When the control unit 41 determines that the distribution information includes the instruction indicating that the delivery within the predetermined area is specified on the next day (step ST6: Yes), the process proceeds to step ST8. Steps ST1, ST2, and ST6 can be executed independently.

In step ST7, the control unit 41 of the distribution service provider server 40 determines whether the distribution request signal has been acquired from the area management server 10. When the control unit 41 determines that the distribution request signal has not been acquired from the area management server 10 (step ST7: No), the process returns to step ST6. Step ST6 can be performed at least once a day. When the control unit 41 determines that the distribution request signal has been acquired from the area management server 10 (step ST7: Yes), the process proceeds to step ST8.

In step ST8 transitioned from step ST6 or step ST7, the control unit 41 creates a schedule (distribution schedule) for transporting the distributed item from a collection/distribution station managed by the distribution service provider to the distributed item handling office 15 in the predetermined area on the same day or the next day. Examples of the collection/distribution station include a collection/distribution post office and a collection/distribution center. The control unit 41 stores the created distribution schedule information in the schedule information database 42b. The control unit 41 reads the distribution schedule information from the schedule information database 42b of the storage unit 42 and transmits the distribution schedule information to the area management server 10. The distribution management unit 114 of the control unit 11 of the area management server 10 stores the received distribution schedule information in the schedule information database 12c. The control unit 41 transmits the distribution information related to the distributed item to the area management server 10 as needed. The distribution management unit 114 of the area management server 10 that has received the distribution information stores the acquired distribution information in the distribution information database 12e.

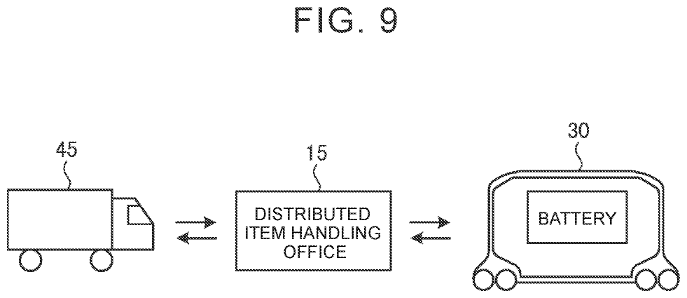

When the process proceeds to step ST9, the control unit 41 reads the distribution schedule information from the schedule information database 42b and transmits the distribution schedule information to the distribution vehicle 45. The distribution vehicle 45 that has received the distribution schedule information carries the distributed item from the collection/distribution station to the distributed item handling office 15 based on the acquired distribution schedule information, as shown in FIG. 9.

Returning to FIG. 8, in step ST10, the work vehicle 30 transmits periodically or as necessary the movement information and the vehicle information of the work vehicle 30 itself to the area management server 10. The control unit 11 of the area management server 10 that has received the movement information and the vehicle information stores the received movement information in the movement management database 12a, and stores the received vehicle information in the vehicle information database 12b.

Next, in step ST11, the distribution management unit 114 of the area management server 10 reads the distribution schedule information from the schedule information database 12c. The distribution management unit 114 reads the movement information and the vehicle information of the work vehicle 30 from the movement management database 12a and the vehicle information database 12b, respectively. The distribution management unit 114 creates a schedule (delivery schedule) for delivering the distributed item to each facility in the predetermined area based on the read distribution schedule information, the vehicle information, and the movement information. The delivery schedule also includes the timing when the work vehicle 30 is charged. The distribution management unit 114 stores the created delivery schedule information in the schedule information database 12c. The distribution management unit 114 reads the delivery schedule information from the schedule information database 12c and transmits the delivery schedule information to the work vehicle 30. The work vehicle 30 stores the received delivery schedule information in the schedule information database 32d. The distribution management unit 114 transmits the distribution information related to the distributed item to the work vehicle 30 as necessary. The control unit 31 of the work vehicle 30 that has received the distribution information stores the acquired distribution information in the distribution information database 32c.

After that, in step ST12, the distribution management unit 114 transmits a delivery instruction signal to the work vehicle 30. The work vehicle 30 that has received the delivery instruction signal reads the delivery schedule information from the schedule information database 32d. The control unit 31 of the work vehicle 30 controls the drive unit 37 in accordance with the delivery schedule information. Thus, the work vehicle 30 moves to the charging facility 70 as shown in FIG. 7, charges the vehicle, and then moves to the distributed item handling office 15 as shown in FIG. 9. At the distributed item handling office 15, the work vehicle 30 receives the distributed item by the work unit 38a of the functional unit 38 and stores the distributed item in the loading unit 38b. The work vehicle 30 may be charged in the course of the delivery route or after the delivery, and the charging timing is not limited as long as the work vehicle 30 is charged at any time of the day. The work vehicle 30 that has stored the distributed item delivers the stored distributed item to each facility in the predetermined area in accordance with the delivery schedule information. This completes the logistics management process according to the present embodiment. The logistics management process according to the present embodiment is executed at least once a day.

According to the embodiment of the present disclosure described above, when the difference value between the predicted value of the power generation amount and the predicted value of the demand amount of the next day in the solar power generation facility 50 derived in the area management server 10 is equal to or greater than the predetermined value, a distribution request signal is transmitted to the distribution service provider server 40. Thus, when the predicted value of the power generation amount is surplus by an amount equal to or greater than a predetermined value in the predetermined area such as a smart city, the distributed item can be transported from the outside to the distributed item handling office 15. Therefore, since the delivery work by the work vehicle 30 can be performed on the next day, even when the electric power generated in the solar power generation facility 50 is surplus, the electric power used by the work vehicle 30 can be increased and the surplus electric power can be supplied to the work vehicle 30. In this way, the electric power generated in the solar power generation facility 50 can be effectively utilized in the logistics system within the predetermined area.

Although the embodiment of the present disclosure has been specifically described above, the present disclosure is not limited to the above-described embodiment, and various modifications based on the technical idea of the present disclosure and embodiments combined with each other can be adopted. For example, the device configurations, display screens, and names given in the above-described embodiment are merely examples, and different device configurations, display screens, and names may be used as necessary.

For example, instead of the work vehicle 30, an electric moving body such as an unmanned aerial vehicle or an automatic robot that can move with electric energy, or the like may be used, and the electric moving body is not necessarily limited to a vehicle.

For example, in the embodiment, deep learning using a neural network is mentioned as an example of machine learning, but machine learning based on other methods may be performed. Other supervised learning, such as support vector machines, decision trees, Naive Bayes, and k-nearest neighbors, may be used. Also, semi-supervised learning may be used instead of supervised learning. Furthermore, reinforcement learning or deep reinforcement learning may be used as machine learning.

Recording Medium

According to the embodiment, a program capable of executing a processing method by various servers 10, 40, 50A, and 60 and the work vehicle 30 can be recorded in a recording medium that is readable by a computer and other machines or devices (hereinafter referred to as “computer or the like”). The computer or the like functions as the control units of the servers and the vehicles as the computer or the like is caused to read the program stored in the recording medium and execute the program. Here, the recording medium that is readable by the computer or the like means a non-transitory storage medium that accumulates information such as data and programs through an electrical, magnetic, optical, mechanical, or chemical action and from which the computer or the like can read the information. Examples of the recording medium removable from the computer or the like among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording medium fixed to the computer or the like include a hard disk and a read-only memory (ROM). Further, a solid state drive (SSD) can be used as the recording medium removable from the computer or the like or as the recording medium fixed to the computer or the like.

### OTHER EMBODIMENTS

Further, in the area management server 10, the work vehicle 30, the distribution service provider server 40, the solar power generation server 50A, and the weather information server 60 according to the embodiment, “unit” can be read as “circuit” or the like. For example, the communication unit can be read as a communication circuit.

The program to be executed by the area management server 10 or the work vehicle 30 according to the embodiment may be configured to be stored in a computer connected to a network such as the Internet and provided through downloading via the network.

In the description of the flowchart in the present specification, the order of the processing between steps is clarified using expressions such as “first”, “after”, and “subsequently”. However, the order of processing required for realizing the embodiment is not always uniquely defined by those expressions. That is, the order of processing in the flowchart described in the present specification can be changed within a consistent range.

In addition, instead of a system equipped with one server, terminals capable of executing a part of the processing of the server may be distributed and arranged in a place physically close to the information processing device to apply edge computing technology that can efficiently communicate a large amount of data and shorten the arithmetic processing time.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. An information processing device comprising:
a processor including hardware, wherein the processor is configured to:
acquire power generation information from a solar power generation server that outputs the power generation information related to power generation in a solar power generation facility, and store the power generation information in a storage unit;
acquire weather information in a predetermined area and an area including the solar power generation facility from a weather information server that outputs the weather information related to weather, and store the weather information in the storage unit;
predict a power generation amount of a next day and derive a predicted value of the power generation amount based on the weather information and the power generation information in the solar power generation facility;
predict a demand amount of electric power to be used in the predetermined area on the next day and derive a predicted value of the demand amount based on the weather information in the predetermined area; and
output a request signal for requesting distribution of a distributed item from an outside of the predetermined area to the predetermined area based on the predicted value of the power generation amount and the predicted value of the demand amount.

2. The information processing device according to claim 1, wherein the information processing device calculates a difference value between the predicted value of the power generation amount and the predicted value of the demand amount, and outputs the request signal when the difference value is equal to or greater than a predetermined value.

3. The information processing device according to claim 1, wherein the processor is configured to:
output the request signal to a distribution service provider server managed by a service provider that distributes the distributed item;
acquire distribution schedule information related to the distribution of the next day from the distribution service provider server;
generate, based on the distribution schedule information, delivery schedule information for delivering the distributed item to a facility in the predetermined area and store the delivery schedule information in the storage unit;
read the delivery schedule information from the storage unit; and
output the delivery schedule information to a work vehicle that delivers the distributed item to the facility in the predetermined area.

4. The information processing device according to claim 3, wherein:
the work vehicle is provided with a battery for storing electric power; and
the delivery schedule information includes information at a time when the battery of the work vehicle is charged.

5. The information processing device according to claim 1, wherein the processor is configured to output a delivery instruction signal for instructing a start of delivery of the distributed item to the work vehicle that delivers the distributed item to the facility in the predetermined area.

6. The information processing device according to claim 5, wherein the processor is configured to acquire vehicle information related to the work vehicle and movement information related to movement of the work vehicle from the work vehicle.

7. An information processing system comprising:
a first device including a first processor and configured to be able to deliver a distributed item to a predetermined facility, the first processor being configured to acquire delivery schedule information related to delivery of the distributed item and output an instruction signal for instructing autonomous movement based on the delivery schedule information;
a second device including a solar panel that converts sunlight into electric power, a storage battery that stores the electric power generated by the solar panel, and a second processor configured to acquire and output power generation information related to power generation from at least one of the solar panel and the storage battery;
a third device including a third processor configured to collect weather information; and
a fourth device including a fourth processor configured to acquire the power generation information from the second device and store the power generation information in a storage unit, acquire the weather information in a predetermined area and an area including the second device from the third device and store the weather information in the storage unit, predict a power generation amount of a next day by the solar panel and derive a predicted value of the power generation amount based on the weather information and the power generation information in the second device, predict a demand amount of electric power to be used in the predetermined area on the next day and derive a predicted value of the demand amount based on the weather information in the predetermined area, and output a request signal for requesting distribution of a distributed item from an outside of the predetermined area to the predetermined area based on the predicted value of the power generation amount and the predicted value of the demand amount.

8. The information processing system according to claim 7, wherein the fourth processor is configured to calculate a difference value between the predicted value of the power generation amount and the predicted value of the demand amount, and output the request signal when the difference value is equal to or greater than a predetermined value.

9. The information processing system according to claim 7, further comprising a fifth device including a fifth processor configured to, based on distribution information including information on a delivery date of the distributed item, manage a distribution vehicle that distributes the distributed item to the predetermined area and generate distribution schedule information for distributing the distributed item to the predetermined area, the fifth device being managed by a service provider that distributes the distributed item, wherein the fourth processor is configured to:
acquire the distribution schedule information related to distribution of the next day from the fifth device;
generate, based on the distribution schedule information, delivery schedule information for delivering the distributed item to a facility in the predetermined area and store the delivery schedule information in the storage unit;
read the delivery schedule information from the storage unit; and
output the delivery schedule information to the first device.

10. The information processing system according to claim 9, wherein the fifth processor is configured to:
determine whether the distribution information includes an instruction content for the delivery of the next day; and
generate the distribution schedule information when the fifth processor determines that the distribution information includes the instruction content for the delivery of the next day.

11. The information processing system according to claim 9, wherein:
the fourth processor is configured to be able to output the request signal to the fifth device; and
the fifth processor is configured to:
determine whether the request signal has been acquired from the fourth device; and
generate the distribution schedule information when the fifth processor determines that the request signal has been acquired.

12. The information processing system according to claim 7, wherein:
the first device is a work vehicle provided with a battery for storing electric power; and
the delivery schedule information includes information at a time when the battery of the work vehicle is charged.

13. The information processing system according to claim 7, wherein the fourth processor is configured to output a delivery instruction signal for instructing a start of the delivery of the distributed item to the first device.

14. The information processing system according to claim 7, wherein:
the first device is a work vehicle provided with a battery for storing electric power; and
the fourth processor is configured to acquire vehicle information related to the work vehicle and movement information related to movement of the work vehicle from the work vehicle.

15. A program that causes a processor including hardware to:
acquire power generation information from a solar power generation server that outputs the power generation information related to power generation in a solar power generation facility, and store the power generation information in a storage unit;
acquire weather information in a predetermined area and an area including the solar power generation facility from a weather information server that outputs the weather information related to weather, and store the weather information in the storage unit;
predict a power generation amount of a next day and derive a predicted value of the power generation amount based on the weather information and the power generation information in the solar power generation facility;
predict a demand amount of electric power to be used in the predetermined area on the next day and derive a predicted value of the demand amount based on the weather information in the predetermined area; and
output a request signal for requesting distribution of a distributed item from an outside of the predetermined area to the predetermined area based on the predicted value of the power generation amount and the predicted value of the demand amount.

16. The program according to claim 15, causing the processor to calculate a difference value between the predicted value of the power generation amount and the predicted value of the demand amount, and output the request signal when the difference value is equal to or greater than a predetermined value.

17. The program according to claim 15, causing the processor to:
output the request signal to a distribution service provider server managed by a service provider that distributes a distributed item;
acquire distribution schedule information related to distribution of the next day from the distribution service provider server;
generate, based on the distribution schedule information, delivery schedule information for delivering the distributed item to a facility in the predetermined area and store the delivery schedule information in the storage unit;
read the delivery schedule information from the storage unit; and
output the delivery schedule information to a work vehicle that delivers the distributed item to the facility in the predetermined area.

18. The program according to claim 17, comprising a battery in which the work vehicle stores electric power, wherein the delivery schedule information includes information at a time when the battery of the work vehicle is charged.

19. The program according to claim 15, causing the processor to output a delivery instruction signal for instructing a start of delivery of the distributed item to the work vehicle that delivers the distributed item to the facility in the predetermined area.

20. The program according to claim 19, causing the processor to acquire vehicle information related to the work vehicle and movement information related to movement of the work vehicle from the work vehicle.
